(19) United States
(12) Patent Application Publication
(10) Pub. No.: US 2014/0118114 A1
(43) Pub. Date: May 1, 2014

(54) BRIDGE BOARD FOR ENHANCING FUNCTIONALITY OF A DATA ACQUISITION DEVICE

(71) Applicant: Quantitative Sampling Technologies, LLC, Boise, ID (US)

(72) Inventors: Jody White, Boise, ID (US); Chris Beasley, Meridian, ID (US); Scott DeHart, Eagle, ID (US); Tim Hickenlooper, Eagle, ID (US)

(73) Assignee: Quantitative Sampling Technologies, LLC, Boise, ID (US)

(21) Appl. No.: 14/067,659

(22) Filed: Oct. 30, 2013

Related U.S. Application Data
(60) Provisional application No. 61/720,269, filed on Oct. 30, 2012.

(51) Int. Cl. G06K 7/10

(52) U.S. Cl. CPC G06K 7/10366
USPC 340/10.1

(57) ABSTRACT

A bridge board for enhancing functionality on a Data Acquisition Device (DAD). The bridge board is configured to be in data communication with the DAD, and the DAD configured to be selectively fired upon receipt of firing instructions from the bridge board. When fired, the DAD is configured to acquire and store DAD data, if DAD data is available for acquisition. In preferred embodiments, the bridge board is configured to allow the DAD to communicate with a controller via serial communication using a 3-wire cable. The bridge board is further configured to generate enhanced DAD data, the enhanced DAD data comprising enhancements made by the bridge board to DAD data received by the bridge board from the DAD. The bridge board thus enables the controller to acquire data from multiple types of DAD, different both in genus and in species, and different in levels of functionality and capability.

### RELATED APPLICATIONS

This application claims the benefit of, and priority to, commonly-invented U.S. Provisional Applications Ser. No. 61/720,269, filed Oct. 30, 2012, the entire disclosure of which application is incorporated herein by reference.

### FIELD OF THE INVENTION

The disclosure of this application is related generally to supervisory computer systems in which a controller processes data acquired from a plurality of remote data acquisition devices, and more specifically to such a supervisory system in which the functionality of at least some of the data acquisition devices is enhanced by local bridge boards communicatively coupled thereto.

### BACKGROUND

Supervisory computer systems are known in the art, in which a controller manages a plurality of Data Acquisition Devices (or “DADs”) communicatively coupled thereto. One exemplary conventional application for such supervisory systems is in the aquatic species Radio Frequency Identification (“RFID”) art. In such an exemplary conventional application, aquatic species such as fish are subcutaneously implanted with RFID tags. Submersible Data Acquisition Devices (known colloquially as “readers”) monitor for the presence of RFID tags. Each RFID tag reader includes an antenna and a tuned circuit which can be “fired” remotely by the controller. Throughout this disclosure, the term “firing” generally means actuating a DAD from a dormant state (in which the DAD will not acquire data even if available) to an active state (in which the DAD will acquire data if available). In the case of an RFID tag reader DAD for use with RFID tags on aquatic species, the term “firing” specifically means activating an antenna associated with an RFID tag reader DAD so that the antenna's field is energized to detect and read RFID tag data, if present. If an RFID tag reader DAD, when fired, detects an RFID tag in the antenna's field, the reader sends corresponding data back to the controller, allowing the detected RFID tag to be identified and the detection occurrence to be logged. In this way, multiple readers may deployed in a network thereof, communicatively coupled to the controller, allowing the controller to monitor for, identify and log data that includes the presence and migration of RFID-tagged aquatic species such as fish.

Conventional supervisory computer systems of the type described above suffer from a number of drawbacks. One drawback is the manufacturing reality that Data Acquisition Devices (“DADs”) are available in many types, from different manufacturers, and thus have non-identical performance specifications. DADs are not uniform in the communications protocols with which they output acquired data. It would be useful to be able to place DADs of non-identical performance specifications, potentially from different manufacturers and outputting data according to differing communications protocols, into a single network thereof supervised by a single controller. It would be further useful if the network was not limited as to the type of DAD included on the network. For example, in the exemplary aquatic species deployment described above, it would be useful if environmental sensor DADs (such as a water temperature thermometer) could be included on the same network as RFID tag reader DADs.

A further drawback of conventional supervisory computer systems is that DADs on the network may be of lower functionality than is optimal. For example, in the exemplary aquatic species deployment described above, RFID tag reader DADs are commercially available (such as the Allflex RM-310) that does no more than output data regarding RFID tags detected and read, if present. It would be useful if the output data of low-functionality DADs on supervisory systems could be enhanced with additional local information around the DAD prior to transmitting back to the controller. For example, in the case of an RFID tag reader DAD monitoring for aquatic species, it would be useful if the DAD could also measure local water temperature when fired, and transmit this temperature data back to the controller, even if there was no newly-detected RFID tag data to send back at that time. Additionally, or alternatively, it would be useful if the DAD could also send back data regarding its own current state, again even if there was no newly-detected RFID tag data to send back at that time.

A further drawback of conventional supervisory computer systems is that the ability of controllers to fire multiple DADs simultaneously is limited. Simultaneous firing would improve overall data acquisition within a networked topology of DADs. The ability of a controller in a supervisory system to fire three DADs simultaneous appears to be beyond the current state of the art.

A further drawback of conventional supervisory computer systems is that differing and complex (and potentially expensive) cable systems are used to communicatively couple the controller to the network of DADs. It would be useful generally if such cable systems were universally simple 3-wire cables over which a standard serial communications protocol was used. Specifically, in the exemplary aquatic species deployment described above, the interconnecting cables supporting the network run underwater over long distances. Performance and economic advantage would be obtained by using a universal simple 3-wire cable for such cabling.

### SUMMARY AND TECHNICAL ADVANTAGES

The inventive disclosure of this application addresses one or more of the above-described drawbacks of the prior art. In one aspect, such inventive disclosure includes a bridge board for enhancing functionality on a Data Acquisition Device (DAD). The bridge board is configured to be in data communication with the DAD, and the DAD configured to be selectively fired upon receipt of firing instructions from the bridge board. When fired, the DAD is configured to acquire and store DAD data, if DAD data is available for acquisition.

The bridge board is configured to allow the DAD to communicate with a controller using a 3-wire cable. As such, and within that bridge board configuration, it will be appreciated that DAD is further configured to output acquired DAD data to the bridge board according to one of a plurality of DAD communications protocols, and that the bridge board is further configured to communicate data with the controller via three internal wires in a multi-wire cable, the internal wires comprising (1) a power wire, (2) a communications wire, and (3) a combined power return and signal reference wire.

The bridge board is further configured to send firing instructions to the DAD responsive to corresponding firing instructions received from the controller. The bridge board is further configured to generate enhanced DAD data, the enhanced DAD data comprising enhancements made by the bridge board to DAD data received by the bridge board from the DAD. The bridge is board further configured to transmit, responsive to transmit instructions received from the controller, the enhanced DAD data to the controller via the three internal wires in the multi-wire cable according to a selected bridge board communications protocol. In some embodiments, the selected bridge board communications protocol comprises serial.

In another aspect, the inventive disclosure of this application includes a controller for supervising remote Data Acquisition Devices (DADs) each via a corresponding bridge board communicatively coupled thereto, the controller comprising a micro-computer, the micro-computer configured to be in network data communication with a plurality of bridge boards. Each bridge board includes a DAD in data communication with the bridge board, the DAD configured to be selectively fired upon receipt of firing instructions from the bridge board, the DAD when fired configured to acquire and store DAD data if DAD data is available for acquisition, the DAD further configured to output acquired DAD data to the bridge board according to one of a plurality of DAD communications protocols.

In this second aspect, the bridge board is further configured to communicate data with the micro-computer via a selected network communications medium. In some embodiments, the selected network communications medium may be selected from among a coaxial cable, a wireless communication link, 2 wires in a multi-wire cable, and 3 wires in a multi-wire cable.

The bridge board is further configured to send firing instructions to the DAD responsive to corresponding firing instructions received from the micro-computer. The bridge board is further configured to generate enhanced DAD data, the enhanced DAD data comprising enhancements made by the bridge board to DAD data received by the bridge board from the DAD. The bridge board is further configured to transmit, responsive to transmit instructions received from the micro-computer, the enhanced DAD data to the micro-computer via the selected network communications medium according to a selected bridge board communications protocol. In some embodiments, the selected bridge board communications protocol comprises serial.

In this second aspect, the micro-computer is further configured to selectively send firing instructions to at least three bridge boards concurrently, and to receive enhanced DAD data. The micro-computer is configured to selectively take at least one action with respect to such received enhanced DAD data. Such actions may be selected from among (1) storing the received enhanced DAD data, (2) further processing the received enhanced DAD data, and (3) further transmitting the received enhanced DAD data to a remote computing device.

In another variation of the second aspect, some of the DADs may have non-identical performance specifications.

It is therefore a technical advantage of the supervisory computer system described in this disclosure for a controller to be able to acquire data, via bridge boards, from multiple types of DADs having non-identical performance specifications. The DADs may be different species of the same genus of DAD (such as, for example, in RFID tag readers, half-duplex or full duplex antennas, or low Q or high Q antennas, or even different manufacturers). The DADs may alternatively be of different genus (such as RFID tag readers or environmental sensors).

The bridge boards for each DAD further allow each DAD to communicate with the controller via a common, selected bridge board communications protocol, which in some embodiments is serial communication via a 3-wire cable. It will thus be appreciated that within this advantage, the DADs may output acquired data in multiple communications protocols and, via the bridge boards, the data may be received by the controller according to the common, selected bridge board communications protocol.

A further technical advantage of the supervisory computer system described in this disclosure is that the controller may fire at least three DADs concurrently.

A further technical advantage of the supervisory computer system described in this disclosure is that data acquired from lower-functionality DADs may be enhanced, via bridge boards, with additional data prior to transmission back to the controller. This enhanced data may or may not include data acquired by the DAD, depending on whether DAD data is available to be acquired by the DAD at the time. In the exemplary embodiment of the DAD being an RFID tag reader, the enhanced data may be data from a local environmental sensor near the tag reader, or diagnostic information regarding the DAD or the bridge board itself (such as current draw or signal noise levels). As noted, the enhanced data may or may not include RFID data acquired by the DAD, depending on whether such RFID data is available to be acquired by the DAD at the time.

A further technical advantage of the supervisory computer system described in this disclosure is that in some embodiments (and particularly embodiments comprising RFID tag reader deployments) it includes advantageous features that, for example, minimize signal noise from antenna readings, or minimize cross talk or avoid data collisions on the DAD network.

A further technical advantage of the supervisory computer system described in this disclosure is that it is particularly suited, in some embodiments, to a deployment for acquiring and processing RFID tag data and other regarding the migration of aquatic species such as fish. It will be appreciated however, that such a deployment is an exemplary embodiment only, and that the supervisory computer system described herein is not limited to any particular type of deployment.

The foregoing has outlined rather broadly the features and technical advantages of the inventive disclosure of this application, in order that the detailed description of the embodiments that follows may be better understood. It will be appreciated by those skilled in the art that the specific embodiments disclosed may be readily utilized as a basis for modifying or designing other structures for carrying out-the same general purposes of the inventive material set forth in this disclosure.

### BRIEF DESCRIPTION OF THE DRAWINGS

For a more complete understanding of embodiments described in detail below, and the advantages thereof, reference is now made to the following drawings, in which:

FIGS. 1A and 1B are functional representations of different exemplary deployments of a supervisory system 100 including controller 101 and bridge boards 110;

FIG. 2 is a functional representation of one exemplary embodiment of controller 101 in more detail;

FIG. 3 is a functional representation of one exemplary embodiment of bridge board 110 in more detail;

FIG. 4A illustrates an embodiment of a data communication protocol 211 over a 3-wire connection; and

FIG. 4B is a functional representation of a data packet 201 in accordance with exemplary data communication disclosed herein.

### DETAILED DESCRIPTION

There now follows a detailed description of one exemplary embodiment of the supervisory computer system described in this disclosure. The following description is for illustrative purposes, describing one presently preferred embodiment. In this embodiment, the supervisory computer system is deployed as a controller acquiring data from a networked plurality of Data Acquisition Devices (“DADs”), including a networked plurality of RFID tag reader DADs. The RFID tag reader DADs are advantageously deployed in a waterway, and are disposed generally to monitor for, and to detect and acquire data from, RFID tags implanted on aquatic species living in the waterway. As previously noted, however, this RFID tag deployment is one exemplary embodiment only, and it will be appreciated that the supervisory computer system described herein is not limited to this embodiment and deployment.

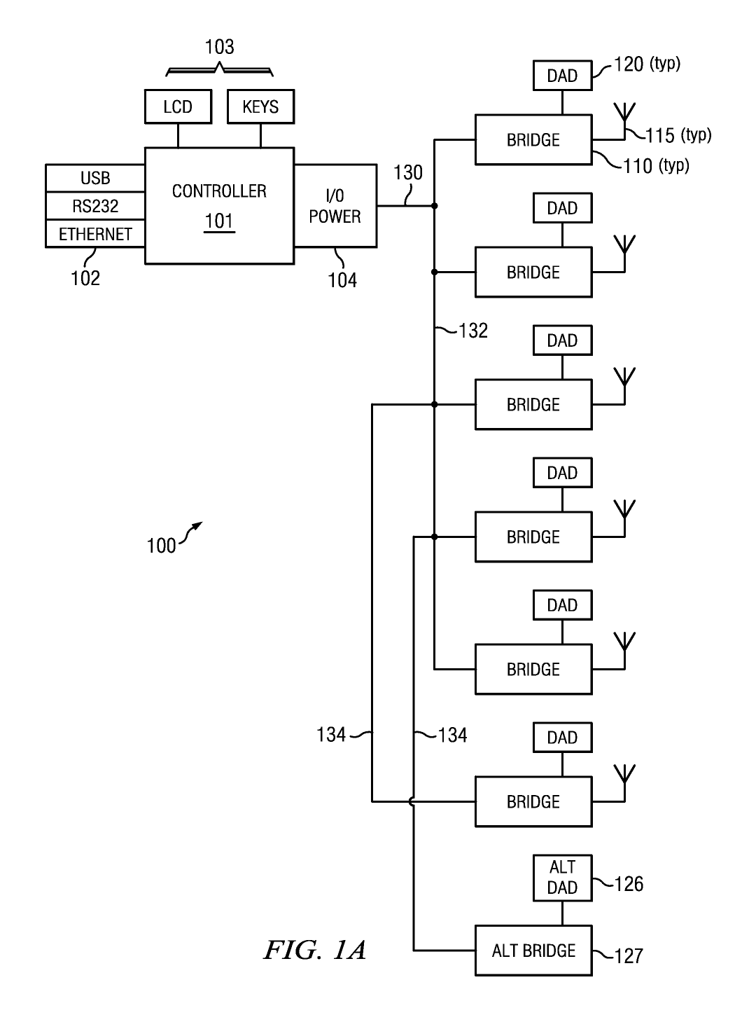

The following description is also made with reference to FIGS. 1A through 4B, described briefly above. Items and parts illustrated on more than one of FIGS. 1A through 4B are shown on such Figures accompanied by the same reference numeral.

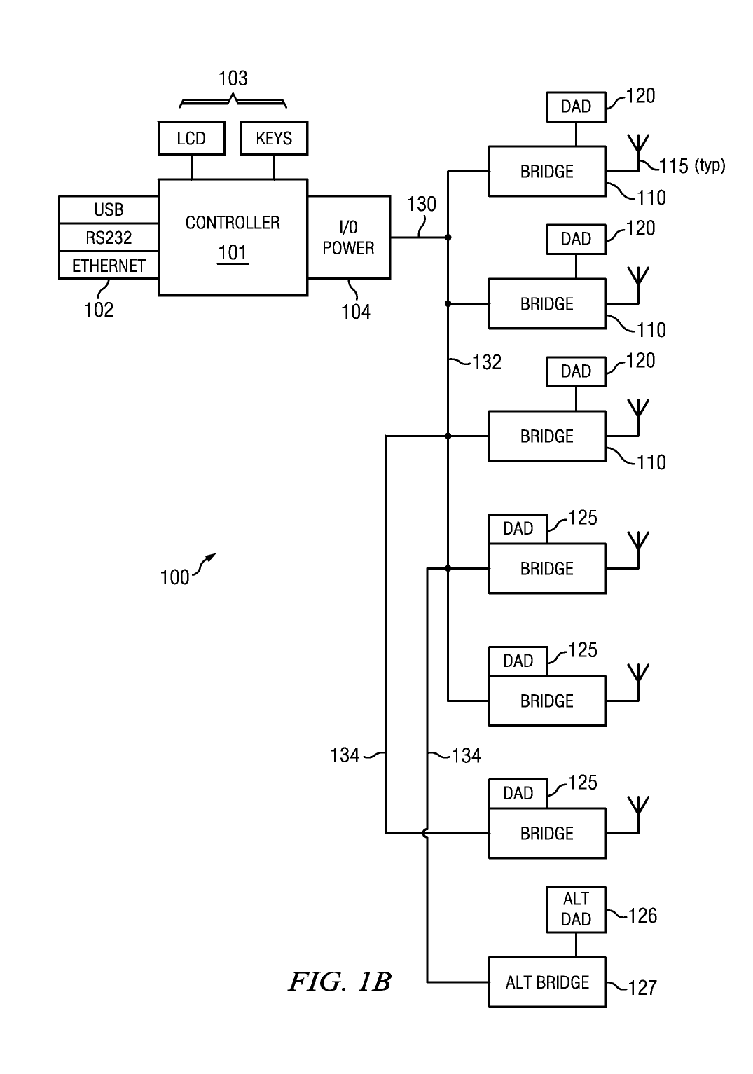

FIGS. 1A and 1B illustrate two exemplary variants of a supervisory computer system 100, each comprising a controller 101. On both FIGS. 1A and 1B, controller 101 includes a combination I/O and power board 104 communicatively coupled to a networked plurality of DADs. The networked plurality of DADs is different in FIGS. 1A and 1B and so each will be described further below with reference to its respective Figure. Although not illustrated, it will be understood that combination I/O and power board 104 receives a power supply (advantageously 15-16 V DC), as further described below with reference to FIG. 2.

Controller 101 on both FIGS. 1A and 1B further comprises user functionality 103 including an LCD display and a keyboard. FIGS. 1A and 1B also illustrate controller 101 comprising output functionality 102, from which data acquired, stored and processed by controller 101 may be further distributed to, for example, a remote computer/server or to portable storage (such as a flash drive). In more specific exemplary embodiments, LCD may be a 128×64 graphics display. RS232 and Ethernet communication is provided for data upload to remote computing devices. Although not illustrated, it will be appreciated that other communication may be provided for further data upload or communication, such as for example, SDI-12, CAN bus or wireless communication.

FIGS. 1A and 1B further illustrate controller 101 communicatively coupled to the networked DADs via 3-wire cable 130. The 3-wire cable 130 enables controller 101 to selectively transmit power to networked DADs in order to “fire” the DAD's upon command. The 3-wire cable 130 further enables controller 101 to exchange data with networked DADs over a universal, serial communications protocol. The network itself may be in a daisy chain configuration (item 132 on FIGS. 1A and 1B), or in a star configuration (item 134 on FIGS. 1A and 1B), or in a combination of both (as illustrated on FIGS. 1A and 1B). In more specific exemplary embodiments, controller 101 can support up to 24 different antenna systems (i.e. 24 different species of RFID tag reader DAD, comprising different manufacturer or performance specifications), addressing over 200 individual RFID tag reader DADs, constrained primarily by multiple variations in the antenna duty cycle. The 3-wire cable 130 provides passive waterproof connections, and is advantageously a double jacket, 3×14 gauge multi-wire cable. The 3-wire cable 130 can advantageously accommodate up to 5000 feet of total wire length (sum of individual segments) in any topology. The primary constraint on length of 3-wire cable 130 is resistance and impedance affecting I/O exchange and power transmission from controller 101 to the networked DADs.

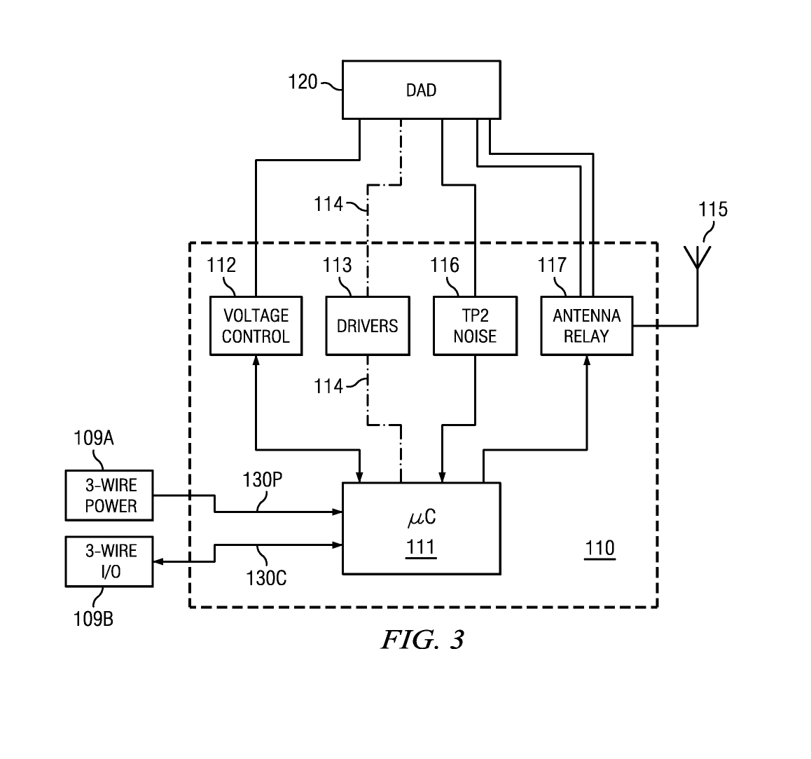

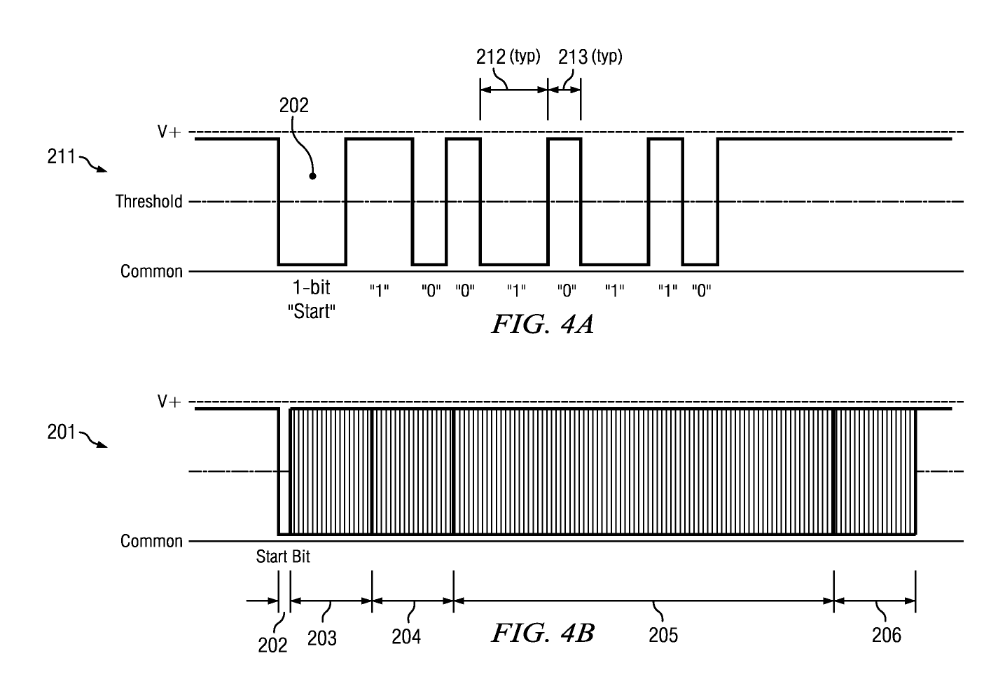

Currently preferred embodiments of the 3-wire cable 130 enable serial communication between controller 101 and networked DADs via the following configuration: (1) a power wire, (2) a communications wire, and (3) a combined power return and signal reference wire. In this configuration, power transmission and serial communication over 3-wire cable 130 may be enabled according to the communications protocols and data collision avoidance techniques described below with reference to FIGS. 4A and 4B (although it will be appreciated that the disclosed communications protocols and collision avoidance techniques are exemplary only).

Although 3-wire cable 130 is a currently preferred embodiment for connecting controller 101 on FIGS. 1A and 1B to networked DADs, it will be understood that the supervisory computer system disclosed herein is not limited in this regard. Other embodiments may connect controller 101 to all or some of the networked DADs via, for example, a coaxial cable, a wireless communication link, and/or a 2-wire cable. The 2-wire embodiment may be enabled by a combined power and communications wire, and a combined power return and signal reference wire. It will be further understood that 3-wire cable 130 as depicted on FIGS. 1A and 1B is not limited to a multi-wire cable having only 3 wires. The 3-wire cable 130 may also be embodied on 3 designated wires in a multi-wire cable having more than 3 wires.

FIG. 1A illustrates one exemplary embodiment of a network of DADs communicatively coupled to controller 101. On FIG. 1A, each one of a plurality of RFID tag reader DADs 120 is communicatively coupled to controller 101 via a corresponding bridge board 110. Bridge boards 110 each further control a corresponding RFID antenna 115 so that each RFID tag reader DAD 120 may acquire RFID data via antenna 115, if available, when fired by its corresponding bridge board 110. Bridge boards 110 further allow RFID tag reader DADs 120 to communicate with controller 101 over 3-wire cable 130 via a universal, serial communications protocol, as described above. Within this feature, bridge boards 110 may thus receive data (and in the example of FIG. 1A, detected RFID tag data) outputted from DADs in any one of a plurality of DAD communications protocols, and re-format the data into the selected serial communications protocol suitable for communication with controller 101 over 3-wire cable 130. It will be recalled from earlier disclosure that in more specific exemplary embodiments, controller 101 can support up to 24 different antenna systems (i.e. 24 different species of RFID tag reader DADs, comprising different manufacturer or performance specifications), addressing over 200 individual RFID tag reader DADs.

It will be further appreciated from FIG. 1A that bridge boards 110 may further allow connectivity between controller 101 and multiple types of DAD 120 on the same network. Again, it will be recalled from earlier disclosure that in more specific exemplary embodiments, controller 101 can support up to 24 different antenna systems (i.e. 24 different species of RFID tag reader DADs, comprising different manufacturer or performance specifications), addressing over 200 individual RFID tag reader DADs. For purposes of illustration, let it be assumed momentarily that DADs 120 as illustrated on FIG. 1A comprise various differing species of RFID tag reader DADs. That is, for purposes of illustration, let it be assumed momentarily that DADs 120 on FIG. 1A are all RFID tag reader DADs, but they vary in functionality and performance specifications, and may not be from the same manufacturer. For example, some RFID tag reader DADs 120 may be configured to communicate with ½ duplex antennas, while others may be configured to communicate with full duplex antennas. Some may be configured for high Q antenna responses, others for lower Q antenna responses. As noted above, some may output data in different communications formats. It will be appreciated that by characterizing a corresponding bridge board 110 for a particular type of DAD 120, the bridge board 110 may output DAD data to the controller 101 in a universally processable format.

It will be further understood from FIG. 1A that data from different types of DADs at the genus level may be also processed by controller 110 on the same network. Once again, for purposes of illustration, let it be assumed momentarily that DADs 120 on FIG. 1A are all RFID tag reader DADs, and that alternative DAD 126 is, for example, an environmental sensor such as a thermometer. Alternative bridge board 127 may output environmental DAD data from alternative DAD 126 in a format that is also universally communicable over 3-wire cable 130 and processable by controller 101. The supervisory computer system disclosed herein is thus not limited to the types of DAD, either by species or by genus, from which the controller may acquire and process data.

Bridge boards 110 (and 127) on FIG. 1A may also enhance the DAD data received from DADs 120 (and 126) before transmitting the enhanced data to controller 101. The ability to enhance DAD data is particularly advantageous when the DAD 120 is of a type that has lower or more limited functionality than might be optimal. When DAD 120 is an RFID tag reader DAD, examples of enhanced data that may be provided by bridge board 110 include (1) data from local environmental sensors (such as thermometers) located at or nearby the corresponding antenna 115, and (2) data regarding a current state of the RFID tag reader DAD 120 itself. Specific examples of data regarding a current state of the DAD 120 include data regarding the frequencies at which the DAD is operating, data regarding measurements of current drawn by DAD 120 at different times, and data regarding measurement of antenna signal noise at different times. It will be appreciated that selected bridge boards 110 may acquire this enhanced data responsive to instructions received from controller 101, and store it on the bridge board until the next antenna read cycle. At that time, the selected bridge boards may transmit the enhanced data back to controller 101 even if there is no newly-detected RFID tag reader DAD data to send back to controller 101 on that cycle.

From the above disclosure and FIG. 1A, it will be apparent that there is an exemplary general cycle of operation of the supervisory computer system disclosed herein. The controller 101 may first characterize or calibrate DADs 120 on its network via instructions to selected bridge boards 110. In the disclosed embodiments, such characterization or calibration may include tuning antennas 115 to an optimal frequency in view of measured signal to noise ratio. In operation, the controller 101 sends firing instructions to a bridge board 110. In the disclosed embodiments, the firing instructions may comprise the controller 101 sending a concurrent power pulse (via combination I/O and power board 104) over the 3-wire cable 130 to selected bridge boards 110 in a pre-determined sequence thereof. Responsive to the power pulse, the bridge boards 110 fire their corresponding antennas 115 to detect and measure RFID data if it is available at that time. The bridge boards 110 may also monitor, measure and store enhanced data per the immediately preceding paragraph. When the power pulse from controller 101 ends, the bridge boards 110 cut power to the antennas 115, whereupon the bridge boards 110 may optionally continue to monitor, measure and store more enhanced data until the next power pulse is received from controller 101. Upon receipt of the next firing instructions (power pulse) from controller 101, the bridge boards 110 may fire the DADs 120 and begin the read cycle again, and may also transmit the enhanced data measured and stored in the previous read cycle to controller 101 along with any acquired DAD data, if DAD data was available for acquisition at that time.

It will be appreciated from the immediately previous paragraph that according to the supervisory computer system disclosed herein, the controller 101 may send firing instructions to any number of bridge boards 110 (and corresponding DADs 120) concurrently. In preferred embodiments, controller 101 sends firing instructions to at least three (3) bridge boards 110 (and corresponding DADs 120) concurrently. Controller 101 receives an instantaneous response from such bridge boards 110 (and corresponding DADs 120) with highly limited, if any, cross talk.

Referring now to FIG. 1B, supervisory computer system 100 is illustrated in distinction to FIG. 1A, in that FIG. 1B illustrates a second exemplary embodiment of a network of DADs communicatively coupled to controller 101. On FIG. 1B, a plurality of RFID tag reader DADs 120 is communicatively coupled to controller 101 via a corresponding bridge board 110 as described above with respect to FIG. 1A. As with FIG. 1A, bridge boards 110 in this plurality on FIG. 1B each further control a corresponding RFID antenna 115 so that each RFID tag reader DAD 120 may acquire RFID data, if available, when fired by its corresponding bridge board 110.

FIG. 1B further depicts combination DAD/bridge board devices 125 also communicatively coupled to controller 101 on the same network. The depiction of combination DAD/bridge board devices 125 on FIG. 1B represents that in accordance with the supervisory computer system disclosed herein, a specific different type of DAD may be included on the same network as the DADs 120 and bridge boards 110 described above in detail with reference to FIG. 1A. Combination DAD/bridge board devices 125 depicted on FIG. 1B represent high-functionality DADs whose overall combined functionality is already optimal according to original manufacture performance specification. This is in direct distinction to the DADs 120 and bridge boards 110 described above in detail with reference to FIG. 1A, in which a lower or limited-functionality DAD 120 is retrofittedly upgraded in functionality by a corresponding bridge board 110.

It will be appreciated that all the disclosure above directed to DADs 120 and corresponding bridge boards 110 with reference to FIG. 1 A is equally applicable to combination DAD/bridge board devices 125 depicted on FIG. 1B. The primary difference between FIGS. 1A and 1B is to illustrate that, in accordance with the supervisory computer system disclosed herein, higher functionality DADs without a retrofitted bridge board may be included on the same network as lower functionality DADs with upgraded functionality provided by a retrofitted bridge board.

FIG. 1B also illustrates, consistent with FIG. 1A, alternative DAD 126 and alternative bridge board 127. The disclosure above directed to these components with reference to FIG. 1A applies equally with reference to FIG. 1B.

FIG. 2 is a more detailed functional representation of one exemplary embodiment of controller 101 as described above and also depicted on FIGS. 1A and 1B. Boxes 101A and 101B on FIG. 2 represent that controller 101 may be embodied at least two boards communicatively coupled together—a display board 101 A and power/IO board 101B communicatively coupled via data and power pathways 107. It will be nonetheless understood that the embodiment illustrated on FIG. 2 is exemplary only, and the controller in the supervisory computer system disclosed herein is not limited in this regard.

Display board 101A on FIG. 2 comprises a micro-computer 105 managing the user functions and data exchange functions of controller 101. The user functions include an LCD display 103A, a keyboard 103B for data entry, and a suitable flash port 103C for flash drive download or upload. The data exchange functions include USB port 102A, an RS232 port 102B for modem connections, audible buzzer 102C and Ethernet 102D (driven by Ethernet adaptor 106).

Power/IO board 101B on FIG. 2 comprises micro-computer 105 further managing power supply and communications functions with Data Acquisition Devices (“DADs”). Micro-computer 105 on power/IO board 101B may be the same micro-computer 105 also operating on display board 101A, or they may be separate micro-computer devices. A voltage source 104S supplies power/IO board 101B via DC volt regulator 104. Specific exemplary embodiments of DC regulator 104 further provide at least the ability to measure associated current. FIG. 2 further depicts a plurality of combination DAD/bridge board devices 125, as described above in more detail with reference to FIG. 1B. As noted above, combination DAD/bridge board devices 125 are high functionality DADs that may perform optimally without a retrofitted bridge board to upgrade overall functionality. The disclosure above associated with FIG. 1B describes how such combination DAD/bridge board devices 125 may be on the same network as lower functionality DADs upgraded with corresponding bridge boards (such network advantageously comprising a 3-wire cable enabling universal power and serial communications). In distinction, FIG. 2 illustrates how, in additional embodiments, higher functionality combination DAD/bridge devices 125 may also be communicatively coupled directly to micro-computer 105 to receive power and communications via alternative network communications protocols 131. Such alternative network communications protocols 131 may include (for example) Ethernet, CAN bus or USB. It will be appreciated that higher functionality combination DAD/bridge board devices 125 on FIG. 2 are not limited to any particular type of DAD. For example, higher functionality combination DAD/bridge board devices 125 may comprise RFID tag readers or environmental monitoring probes.

FIG. 2 also illustrates much of the functionality also described above with reference to FIG. 1A. FIG. 2 depicts a plurality of lower functionality DADs 120 with corresponding bridge boards 110 communicatively coupled to micro-computer 105 on power/IO board 101B via power and communications components 130P and 130C of 3-wire cable 130 (from FIG. 1A). On FIG. 2, micro-computer 105 provides 3-wire voltage control 108A and 3-wire communication control 108B over corresponding 3-wire power and communications hardware 109A and 109B. In specific exemplary embodiments, 3-wire voltage control 108A comprises control over power on/off, control over an automatic maximum current limit, and control over current measurement itself. 3-wire communication control 108B comprises control over power on/off and control over an automatic maximum current limit.

Micro-computer 105 on power/IO board 101B on FIG. 2 also provides, by way of example, temperature control 108C over temperature sensor 109C. In specific exemplary embodiments, temperature control 108C provides at least a voltage source to sensor 109C and a read buffer.

Micro-computer 105 on power/IO board 101B on FIG. 2 also provides, by way of example, communications drivers 108D to enable communications with remote computing devices 109D via modem directly off power/IO board 101B. In specific exemplary embodiments, communications drivers 108D provide at least an RS232 connection.

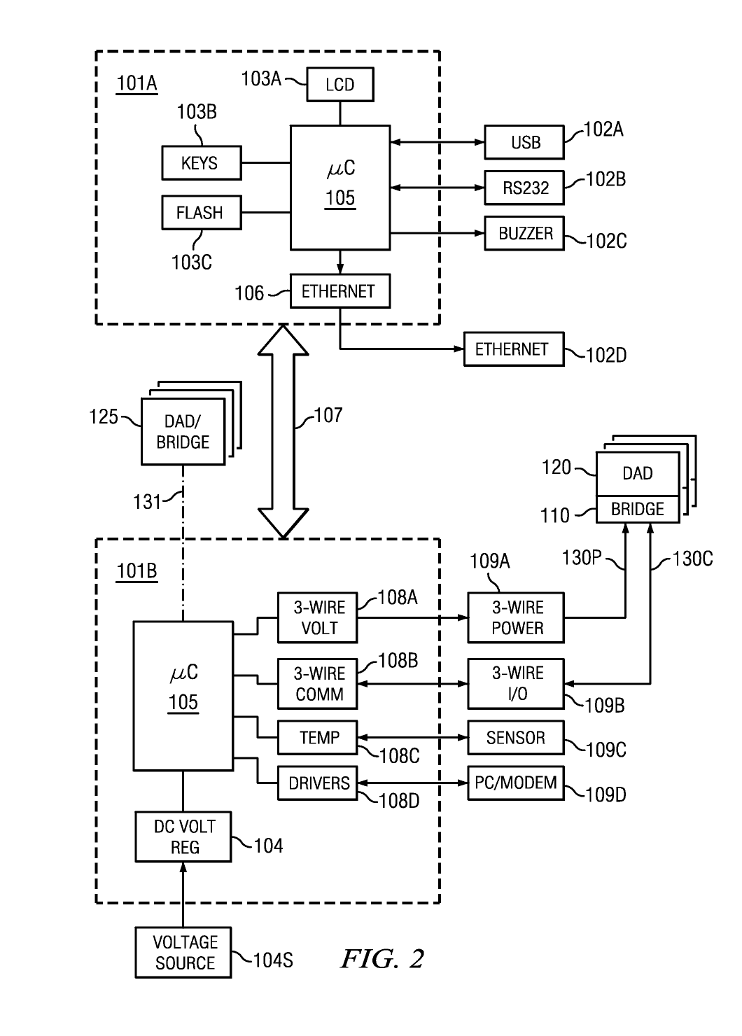

FIG. 3 is a more detailed functional representation of one exemplary embodiment of bridge board 110 as described above and also depicted on FIGS. 1A and 1B. Bridge board 110 on FIG. 3 comprises micro-computer 111 communicatively coupled to 3-wire power and communications hardware 109A and 109B from FIG. 2, over power and communications components 130P and 130C of 3-wire cable 130, described above with reference to FIG. 2. Although not specifically illustrated on FIG. 3, the 3-wire power functionality of micro-computer 111 advantageously provides at least a low pass filter and surge protection via voltage regulator circuitry. Further, although again not illustrated on FIG. 3, the 3-wire communications functionality of micro-computer 111 advantageously provides at least a ground reference level shift.

FIG. 3 further depicts micro-computer 111 communicatively coupled to RFID tag reader Data Acquisition Device (“DAD”) 120. Micro-computer 111 provides variable voltage control 112. Specific exemplary embodiments of variable voltage control 112 provide at least an adjustable voltage, an automatic current limit and measurement of current itself to RFID tag reader DAD 120. Micro-computer 111 further provides drivers 113, so that RFID tag reader DAD 120 may communicate with bridge board 110 according to any one of a plurality of DAD communications protocols (such plurality of DAD communications protocols represented on FIG. 3 by chain-broken line 114). Specific exemplary embodiments of drivers 113 provide at least an RS232 connection.

Micro-computer 111 on FIG. 3 further provides active noise suppression 116. Although in specific exemplary embodiments, active noise suppression 116 comprises real-time sampling of Allflex TP2 noise values (suitable when RFID tag reader DAD 120 is an Allflex RM-310 RFID tag reader board), it will be understood that active noise suppression 116 is not limited in this regard.

Micro-computer 111 on FIG. 3 further provides antenna relay 117 coupled to antenna 115. Micro-computer 111 may cause antenna relay 117 to close and open responsive to firing instructions from controller 101 on (for example) FIG. 1A. The closing of antenna relay 117 causes antenna 115 to become active, such as at the beginning of a read cycle. The opening of antenna relay 117 causes antenna 115 to become inactive, such as at the end of the read cycle. Across multiple bridge boards 110 and corresponding RIFD tag reader DADs 120, the function of opening antenna relays 117 when antennas 115 are not in read cycles promotes passive noise suppression by disabling noise coupling between such inactive antennas 115.

Reference to FIGS. 4A and 4B should now be made in the following description of an exemplary I/O method for use transmitting power and data over a 3-wire cable, as more generally described with reference to FIG. 1 A above. Data is communicated between the controller (item 101 on FIG. 1A) and the bridge boards (item 110 on FIG. 1A) with “packets” of information. As illustrated on FIG. 4B, a data packet 201 comprises five sections: (1) start bit 202 (low voltage for at least one “1” bit time length, and preferably two “1” bit time lengths); (2) address byte 203; (3) length of data value 204 (1 to 255); (4) data bytes 205; and (5) checksum byte 206. In specific exemplary embodiments, checksum byte 206 may be a modified Fletcher-8. Packets 201 are variable length, and may have a length from 4 bytes to 258 bytes.

With reference now to FIG. 4A, data communication protocol 211 is illustrated with bits determined by their length, in which a “1” bit 212 is about twice the length of a “0” bit 213. As illustrated on FIG. 4A, a change in state from “high” to “low” signals the end of one bit and the beginning of the next bit. The length of time at a particular state (high or low) determines whether the bit is a “1” bit 212 or a “0” bit 213. The trailing edge of a bit is used for timing. The leading edge of a bit is assumed to be noisy (multiple voltage spikes and edges). The micro-computer on a bridge board filters this edge by only looking for the next transition after waiting 90% of the time of a “0” bit length.

All communication is originated by the controller. A command packet from the controller may or may not have a reply packet from the bridge board (for example, a reset command does not have a reply).

All bridge boards comprise a “global” address of 0x00. All bridge boards further comprise a unique 4-byte serial number assigned to the bridge board during manufacturing. In actual network deployment, however, each bridge board may instead have a 1-byte address assigned to it in order to simplify communication addressing. There are many commands and packets defined for managing bridge boards, setting values on a specific bridge board, and to issue commands for detecting and reporting, for example, RFID tag data, current measurement, and signal noise measurements.

There now follows a description of an exemplary Collision Detection and Corruption Avoidance method, useful when multiple bridge boards are communicating concurrently with a controller over the 3-wire network. In the case that the controller wants to inventory all of the bridge boards connected to the 3-wire cable, it can send a “Read Serial Number” command to the global address, 0x00. Each of the bridge boards will then start to send their unique serial numbers over the 3-wire cable. Each bridge board then follows two rules for sending bits. First, before driving the I/O line “low” (reference FIG. 4A), a current bridge board looks to see if the I/O line has already been driven low. This would mean that another bridge board has already driven the I/O line low. In this case the current bridge board backs off (stops sending), and allows the other bridge board to complete successfully. Second, the same process is followed by the current bridge board before driving the I/O line “high”. The result is that one of the bridge boards will successfully send its serial number. The controller will then send a “Sleep” command to that serial number, which will keep that bridge board from communicating over the 3-wire cable until it receives a “reset” command. When there are no more bridge boards that respond, a full inventory has been completed and a “reset” command is sent.

Although the inventive material in this disclosure has been described in detail along with some of its technical advantages, it will be understood that various changes, substitutions and alternations may be made to the detailed embodiments without departing from the broader spirit and scope of such inventive material as set forth in the following claims.

We claim:

1. A bridge board for enhancing functionality on a Data Acquisition Device (DAD), comprising:
a bridge board configured to be in data communication with a DAD, the DAD configured to be selectively fired upon receipt of firing instructions from the bridge board, the DAD when fired configured to acquire and store DAD data if DAD data is available for acquisition, the DAD further configured to output acquired DAD data to the bridge board according to one of a plurality of DAD communications protocols;
the bridge board further configured to communicate data with a controller via three internal wires in a multi-wire cable, the internal wires comprising (1) a power wire, (2) a communications wire, and (3) a combined power return and signal reference wire;
the bridge board further configured to send firing instructions to the DAD responsive to corresponding firing instructions received from the controller, the bridge board further configured to generate enhanced DAD data, the enhanced DAD data comprising enhancements made by the bridge board to DAD data received by the bridge board from the DAD if DAD data is available for acquisition; and
the bridge board further configured to transmit, responsive to transmit instructions received from the controller, the enhanced DAD data to the controller via the three internal wires in the multi-wire cable according to a selected bridge board communications protocol.

2. The bridge board of claim 1, in which the DAD is selected from the group consisting of:
(a) an RFID tag reader; and
(b) an environmental sensor.

3. The bridge board of claim 1, in which the bridge board and the DAD comprise passive waterproof connections.

4. The bridge board of claim 1, in which the selected bridge board communications protocol comprises serial.

5. The bridge board of claim 1, in which the enhanced DAD data includes at least one enhancement made to DAD data selected from the group consisting of:
(a) data regarding a monitored state of the DAD combined with the DAD data if the DAD data is available for acquisition; and
(b) data from at least one environmental sensor combined with the DAD data if the DAD data is available for acquisition.

6. The bridge board of claim 1, in which the DAD is an RFID tag reader, and in which the enhanced DAD data includes at least one enhancement made to DAD data selected from the group consisting of:
(a) data regarding measurements of current drawn by the DAD at different times; and
(b) data regarding measurements of antenna signal noise at different times.

7. The bridge board of claim 1, in which the DAD is an RFID tag reader including an antenna, and in which the bridge board further comprises a relay, the bridge board further configured to suppress antenna noise coupling by causing the relay to cut power to the antenna when the DAD is in a state of not being fired by the bridge board.

8. The bridge board of claim 1, in which the bridge board comprises a noise suppression circuit configured to reduce signal noise during communication between the bridge board and the controller.

9. A bridge board for enhancing functionality on a Data Acquisition Device (DAD), comprising:
a bridge board configured to be in data communication with a DAD, the DAD configured to be selectively fired upon receipt of firing instructions from the bridge board, the DAD when fired configured to acquire and store DAD data if DAD data is available for acquisition, the DAD further configured to output acquired DAD data to the bridge board according to one of a plurality of DAD communications protocols;
the bridge board further configured to communicate data with a controller via a selected controller-bridge board communications medium;
the bridge board further configured to send firing instructions to the DAD responsive to corresponding firing instructions received from the controller, the bridge board further configured to generate enhanced DAD data, the enhanced DAD data comprising enhancements made by the bridge board to DAD data received by the bridge board from the DAD if DAD data is available for acquisition; and
the bridge board further configured to transmit, responsive to transmit instructions received from the controller, the enhanced DAD data to the controller via the selected controller-bridge board communications medium according to a selected bridge board communications protocol.

10. The bridge board of claim 9, in which the controller-bridge board communications medium is selected from the group consisting of:
(a) a coaxial cable;
(b) a wireless communication link;
(c) two internal wires in a multi-wire cable, the internal wires comprising (1) a combined power and communications wire, and (2) a combined power return and signal reference wire; and
(d) three internal wires in a multi-wire cable, the internal wires comprising (1) a power wire, (2) a communications wire, and (3) a combined power return and signal reference wire.

11. The bridge board of claim 9, in which the selected bridge board communications protocol comprises serial.

12. The bridge board of claim 9, in which the enhanced DAD data includes at least one enhancement made to DAD data selected from the group consisting of:
(a) data regarding a monitored state of the DAD combined with the DAD data if DAD data is available for acquisition; and
(b) data from at least one environmental sensor combined with the DAD data if DAD data is available for acquisition.

13. The bridge board of claim 9, in which the DAD is an RFID tag reader, and in which the enhanced DAD data includes at least one enhancement made to DAD data selected from the group consisting of:
(a) data regarding measurements of current drawn by the DAD at different times; and
(b) data regarding measurements of antenna signal noise at different times.

14. The bridge board of claim 9, in which the DAD is an RFID tag reader including an antenna, and in which the bridge board further comprises a relay, the bridge board further configured to suppress, antenna noise coupling by causing the relay to cut power to the antenna when the DAD is in a state of not being fired by the bridge board.

15. The bridge board of claim 9, in which the bridge board comprises a noise suppression circuit configured to reduce signal noise during communication between the bridge board and the controller.
